(19) United States
(12) Patent Application Publication
(10) Pub. No.: US 2016/0154084 A1
(43) Pub. Date: Jun. 2, 2016

(54) INFORMATION PROCESSING APPARATUS, POSITIONING METHOD, AND STORAGE MEDIUM

(71) Applicant: KABUSHIKI KAISHA TOSHIBA, Tokyo (JP)

(72) Inventors: Jumpei OGAWA, Fuchu Tokyo (JP); Hiroyuki INAMURA, Hachioji Tokyo (JP); Yoshiki NAMBA, Kawasaki Kanagawa (JP)

(21) Appl. No.: 14/931,164

(22) Filed: Nov. 3, 2015

(30) Foreign Application Priority Data
Dec. 1, 2014 (JP) 2014-243523

(51) Int. Cl. G01S 5/02

(52) U.S. Cl. CPC G01S 5/0294; G01S 5/0289

(57) ABSTRACT

An information processing apparatus connected to a wireless base station configured to wirelessly communicate with a plurality of terminals, the wireless base station providing a predetermined point on a map to each of the plurality of the terminals as a reference position serving as a positioning reference. The information processing apparatus includes a information acquisition processor, a position calculator, a memory, a proximity detector, and a position updater. The proximity detector determines existence of a proximity terminal within a range of a preset proximity distance based on the radio field intensity on the inter-terminal communication for each of the plurality of the terminals obtained from each of the plurality of the terminals. The position updater updates the measured positions of the relevant terminal within the range of the proximity distance stored in the memory by using the estimated position of the proximity terminal determined as existing within the range of the proximity distance by the proximity detector.

### CROSS REFERENCE TO RELATED APPLICATION

This application is based upon and claims the benefit of priority from the prior Japanese Patent Application No. 2014-243523, filed on Dec. 1, 2014; the entire contents of which are incorporated herein by reference.

### FIELD

Embodiments described herein relate generally to an information processing apparatus, a positioning method, and a storage medium.

### BACKGROUND

In recent years, services that specify positions of walking bodies such as a person, an animal, and a robot in roofed premises such as a hall and a building have been increasing, and accordingly, an indoor positioning system has been drawing attention.

In a building, since a radio wave of GPS cannot be received, dead reckoning technology in which a positioning terminal itself worn by a walking body specifies a movement position on a map while detecting the movement from a starting point is generally used.

The conventional dead reckoning technology has a problem that a positioning error becomes larger in according with an increase of the moving distance or the elapsed time from the starting point.

### BRIEF DESCRIPTION OF THE DRAWINGS

FIG. 1 is a configuration view illustrating one embodiment of a positioning system.

FIG. 2 is a block diagram illustrating a first embodiment of a functional configuration of the positioning system.

FIG. 3 is a flowchart illustrating the operation (processing) of a reference station.

FIG. 4 is a flowchart illustrating the operation (processing) of a pedestrian terminal.

FIG. 5 is a flowchart illustrating the operation (processing) of a server.

FIG. 6 is a block diagram illustrating a second embodiment of the functional configuration of the positioning system.

FIG. 7 is a flowchart illustrating the operation (processing) of the second embodiment.

FIG. 8 is a block diagram illustrating a third embodiment of the functional configuration of the positioning system.

FIG. 9 is a flowchart illustrating the operation (processing) of the third embodiment.

FIG. 10 is a block diagram illustrating a fourth embodiment of the functional configuration of the positioning system.

FIG. 11 is a flowchart illustrating the operation (processing) of the fourth embodiment.

FIG. 12 is a block diagram illustrating a fifth embodiment of the functional configuration of the positioning system.

FIG. 13 is a flowchart illustrating the operation (processing) of the fifth embodiment.

FIG. 14 is a block diagram illustrating a sixth embodiment of the functional configuration of the positioning system.

FIG. 15 is a flowchart illustrating the operation (processing) of the sixth embodiment.

FIG. 16 is a block diagram illustrating a seventh embodiment of the functional configuration of the positioning system.

FIG. 17 is a flowchart illustrating the operation (processing) of the seventh embodiment.

FIG. 18 is a block diagram illustrating an eighth embodiment of the functional configuration of the positioning system.

FIG. 19 is a flowchart illustrating the operation (processing) of the eighth embodiment.

### DETAILED DESCRIPTION

An information processing apparatus connected to a wireless base station configured to wirelessly communicate with a plurality of terminals, the wireless base station providing a predetermined point on a map to each of the plurality of the terminals as a reference position serving as a positioning reference, each of the plurality of terminals being configured to obtain walking information indicating a walking movement of a walking user, each of the plurality of the terminals initially passing the reference position with the walking user. The information processing apparatus includes a information acquisition processor, a position calculator, a memory, a proximity detector, and a position updater. The information acquisition processor obtains the walking information, an identification information, a passage time at the reference position, and a radio field intensity on inter-terminal communication with a counterpart terminal from each of the plurality of the terminals. The position calculator calculates an estimated position of each of the plurality of the terminals based on the walking information of each of the plurality of the terminals sequentially obtained by the information acquisition processor when and after each of the plurality of the terminals passes the reference position. The memory stores a measured position of each of the plurality of the terminals in association with a respective identification information of each of the plurality of the terminals. The proximity detector determines existence of a proximity terminal within a range of a preset proximity distance based on the radio field intensity on the inter-terminal communication for each of the plurality of the terminals obtained from each of the plurality of the terminals. The position updater updates the measured positions of the relevant terminal within the range of the proximity distance stored in the memory by using the estimated position of the proximity terminal determined as existing within the range of the proximity distance by the proximity detector.

Hereinafter, embodiments according to the present invention will be described in detail with reference to the drawings.

### First Embodiment

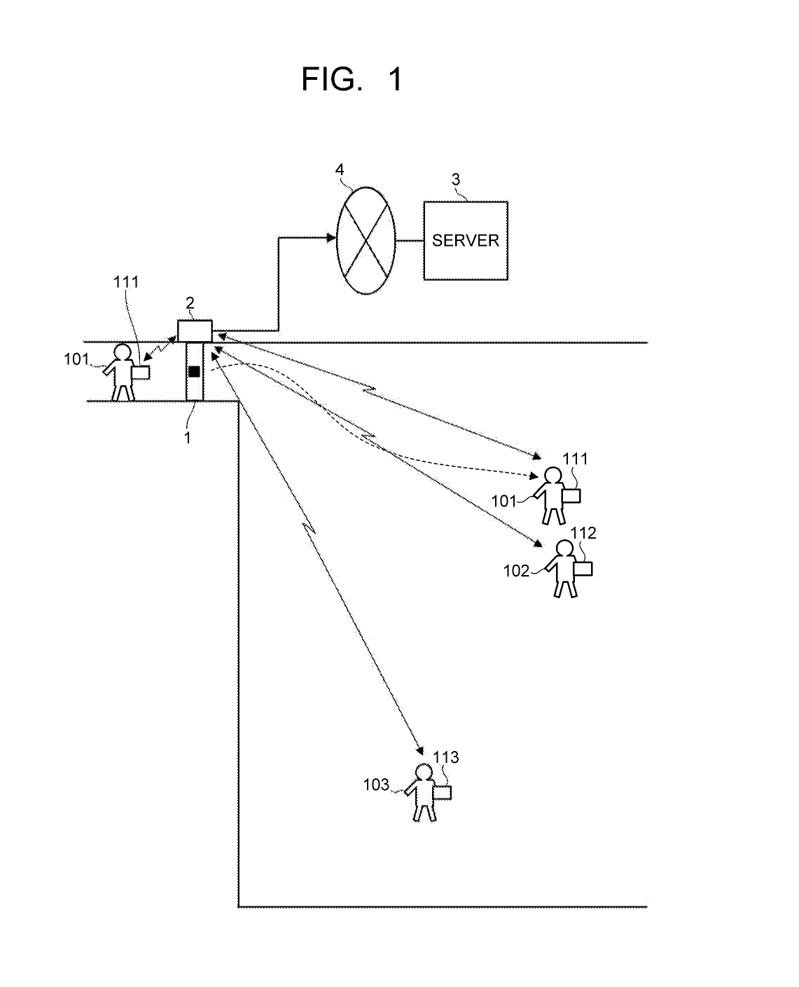

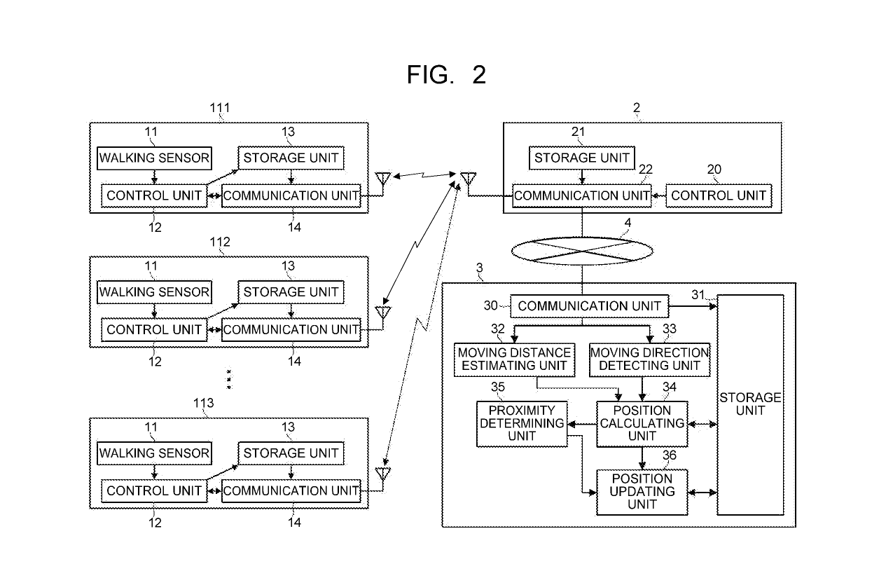

FIG. 1 is a view illustrating the configuration of a positioning system, and FIG. 2 is a block diagram illustrating a functional configuration of the positioning system.

As illustrated in FIG. 1 and FIG. 2, the positioning system includes: a gate opening/closing device 1 (hereinafter, referred to as a “gate device 1”) installed at an entrance (security gate or the like) of a building; a reference station 2 as a wireless base station installed at the position of the gate device 1; pedestrian terminals 111 to 113 as portable terminals for measuring positions of (for positioning) pedestrians by dead reckoning, which are carried by a plurality of pedestrians 101 to 103 as walking bodies who pass the entrance of the building to enter the building and move; and a server computer 3 (hereinafter, referred to as a “server 3”) as an information processing apparatus connected to the gate device 1 and the reference station 2 via a communication network 4 such as LAN. The pedestrian terminals 111 to 113 are pedestrian information transmitting devices.

That is, the positioning system includes: the pedestrian terminals 111 to 113 worn by the pedestrians 101 to 103; the wireless base station 2 which sets a predetermined point on a map that the pedestrian terminals 111 to 113 pass, as a reference position serving as a positioning reference, and which wirelessly communicates with the pedestrian terminals 111 to 113 that pass the reference position to receive information including walking information from the pedestrian terminals 111 to 113; and the server 3 which is connected to the wireless base station 2 via the communication network 4 to obtain, from the wireless base station 2, the walking information received by the wireless base station 2 from the pedestrian terminals 111 to 113.

The gate device 1 detects the passage of the pedestrians 101 to 103 or the pedestrian terminals 111 to 113 based on the operation of an opening/closing mechanism such as a door and notifies the detected information to the reference station 2 through a communication line or the like. Besides, when the pedestrian terminals 111 to 113 each have a near field wireless communication function such as NFC, putting antenna parts of the pedestrian terminals 111 to 113 in front a NFC communication device of the gate device 1 enables the gate device 1 to detect that the pedestrian terminals 111 to 113 have passed this position.

A means for detecting the passage of the pedestrians 101 to 103 at the installation position of the gate device 1 may be a wireless communication means such as, for example, an acoustic wave sensor, an optical sensor, or an image sensor, or may be a pressure sensitive sensor buried in a road surface (sensor that operates when stepped on by a person's foot) or the like, instead of the means for detecting the opening/closing of the opening/closing mechanism

The reference station 2 includes: a storage unit 21 in which a reference position (installation position, positional coordinates, or the like of the gate device 1) serving as a positioning reference is stored; a communication unit 22 which communicates with the pedestrian terminals 111 to 113 having entered a local wireless communication area of the reference station 2; and a control unit 20 as a controller. The communication unit 22 communicates also with the gate device 1 via a communication line or the like.

The reference position is an absolute position (latitude and longitude, or the like) on a map, serving as the positioning reference (starting point of the positioning) of this system. The reference station 2 has a function of transmitting the reference position and a function as a wireless access point. If a wireless communication device for wireless access point can be installed separately from the reference station 2, it may be provided separately from the reference station 2.

The communication unit 22 has a wireless communication function of, for example, Bluetooth Low Energy (BLE), wireless LAN, or the like, and performs wireless communication over a short distance with the pedestrian terminals 111 to 113 in the wireless communication area of, for example, about several meters to about several ten meters.

BLE is one of extended specifications of Bluetooth being one of the short-distance wireless communication technologies and enables communication with very low power. In the case of the wireless LAN, an about several ten meter range is the wireless communication area.

The control unit 20 detects the time of passage at which each of the pedestrian terminals 111 to 113 passes the position of the gate device 1 by communicating with the gate device 1 and the pedestrian terminals 111 to 113. The control unit 20 controls the communication unit 22 to transmit, to the serve 3, information including identification information (terminal ID) and the time of passage of each of the pedestrian terminals 111 to 113 carried by the pedestrians 101 to 103 having passed the position of the gate device 1. Further, the control unit 20 controls the communication unit 22 to wirelessly transmit the reference position read from the storage unit 21 to the pedestrian terminals 111 to 113.

The pedestrian terminals 111 to 113 each have a walking sensor 111 as a walking information detector, a control unit 12, a storage unit 13, a communication unit 14, and so on.

The walking sensor 11 measures (detects) the walking information regarding a walking motion. The walking information is information of, for example, the number of steps, a walking direction (moving direction), and so on. The number of steps may be regarded as a moving distance because multiplying it by a length of a step gives the moving distance. When the walking information is transmitted to the server 3, the terminal ID being the identification information of the individual terminal, the time of passage, and so on are also transmitted together.

The communication unit 14 has a function of wireless LAN or the like, to wirelessly communicate with the reference station 2 and the other pedestrian terminals 111 to 113 and obtains the terminal IDs from the other terminals by the wireless communication with the terminals.

The storage unit 13 is, for example, a memory, and the walking information, the time, and so on are stored therein. In the storage unit 13, the terminal IDs obtained from the other terminals by the wireless communication with the other terminals are also stored. In the storage unit 13, the terminal ID as the identification information of the own terminal is stored in advance.

The control unit 12 detects radio field intensities of the other terminals by the wireless communication with the other terminals and stores the detected radio field intensities in the storage unit 13 on per terminal ID basis.

The control unit 12 has a clock function, stores the walking information detected by the walking sensor 11 in the storage unit 13 in correspondence to the time as required, and transmits the walking information and the time in association with the own terminal ID together with the other terminal ID, the radio field intensity, and so on, through the communication unit 14 at a predetermined timing (for example, at regular one minute intervals or when the terminal communicates with the other terminal or comes into proximity to the other terminal).

As illustrated in FIG. 2, the server 3 includes a communication unit 30 as a communication device, a storage unit 31 as a memory, a moving distance estimating unit 32 as a moving distance calculator, a moving direction detecting unit 33 as a moving direction detector, a position calculating unit 34 as a position calculator, a proximity determining unit 35 as a proximity detector, a position updating unit 36 as a position updater, and so on.

The communication unit 30 is, for example, a LAN interface or the like, receives, from the reference station 2, pieces of the information on the pedestrian terminals 111 to 113, which are obtained by the reference station 2 by the wireless communication with the pedestrian terminals 111 to 113, and stores pieces of the information in the storage unit 31 and at the same time gives pieces of the information to the moving distance estimating unit 32 and the moving direction detecting unit 33.

The communication unit 30 functions as a information acquisition processor which obtains, on per terminal basis, pieces of the walking information of the pedestrian terminals 111 to 113, the terminal IDs of the pedestrian terminals 111 to 113, the times of passage at which the pedestrian terminals 111 to 113 pass the reference position, and the radio field intensities by the inter-terminal communication, from the reference station 2. As the communication unit 30, a wireless communication means such as, for example, wireless LAN, BLE, RFID, or NFC may be used besides a wired communication means.

The moving distance estimating unit 32 estimates (calculates, computes) a moving distance from the position of the gate device 1 (reference position), based on the walking information (the number of steps, the time of passage) of each of the pedestrian terminals 111 to 113 obtained by the communication unit 30 and the reference position stored in advance.

The moving direction detecting unit 33 detects the facing directions of the pedestrians 101 to 103 and the moving directions of the pedestrian terminals 111 to 113 based on pieces of the walking information of the pedestrian terminals 111 to 113.

The position calculating unit 34 calculates the position (absolute position) of each of the terminals on the map based on information about the moving distance estimated by the moving distance estimating unit 32 and the facing direction detected by the moving direction detecting unit 33.

That is, the above-described moving distance estimating unit 32, moving direction detecting unit 33, and position calculating unit 34 function as a position calculator which finds the moving direction, the moving distance, and/or the elapsed time of each of the pedestrian terminals 111 to 113 based on pieces of the walking information of each of the pedestrian terminals which are sequentially obtained by the communication unit 30 when and after the terminal passes the reference position, and calculates the estimated position of each of the pedestrian terminals 111 to 113 at this point in time.

In the storage unit 31, the reference position (the installation position, the positional coordinates, or the like of the gate device 1) serving as the reference of the positioning is stored as in the reference station 2. The storage unit 31 has a position registration area and a primary memory area, and stores, in the position registration area, the located positions of the pedestrian terminals 111 to 113 in association with the respective terminal IDs. Further, in the primary memory area, pieces of the information obtained from the pedestrian terminals 111 to 113 are stored. For example, the terminal position, the terminal ID, the time, the walking information, and so on are stored in the primary memory area on per terminal basis.

The proximity determining unit 35 detects the proximity of the pedestrian terminals 111 to 113 at current positions of the pedestrian terminals, based on the field intensities (radio field intensities) of the radio waves between the pedestrian terminals 111 to 113, pieces of the walking information, and the moving distances, which are received from the pedestrian terminals 111 to 113, and the calculated (estimated) positions of the pedestrian terminals 111 to 113, and so on.

For example, the pedestrian terminal 111 detects the radio field intensity from the pedestrian terminal 112 and the radio field intensity from the pedestrian terminal 113 and sends them to the server 3 as one piece of information of the pedestrian terminal 111. The proximity of the pedestrian terminals 111 to 113 is determined based on whether or not the plural pedestrian terminals exist within a range of a prescribed proximity distance that is set in advance.

The position updating unit 36 updates the positions (absolute coordinates such as the latitudes and the longitudes) of the pedestrian terminals 111 to 113 stored in the storage unit 31, by using the estimated positions of the pedestrian terminals 111 to 113 determined as existing within the range of the proximity distance by the proximity determining unit 35. In updating the positions of the pedestrian terminals 111 to 113, the positions of the pedestrian terminals 111 to 113 may be updated when it is determined that the positions are to be updated after it is determined whether to update the positions or not.

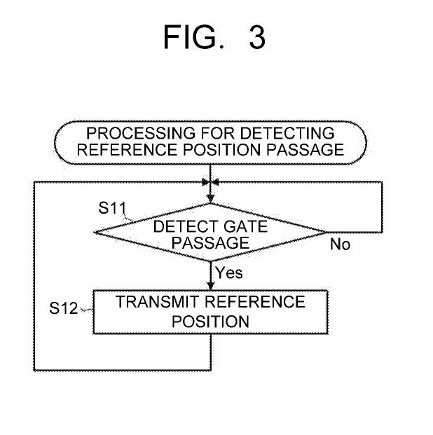

Next, the operation (processing) of the positioning system of the first embodiment will be described. First, the operation (processing) of the reference station 2 will be described with reference to the flowchart in FIG. 3. In the reference station 2, when it is detected that the pedestrians 101 to 103 or the pedestrian terminals 111 to 113 have passed the position of the gate device 1 (Step S11 in FIG. 3), the control unit 20 reads the reference position from the storage unit 21 and transmits it through the communication unit 22 (Step S12).

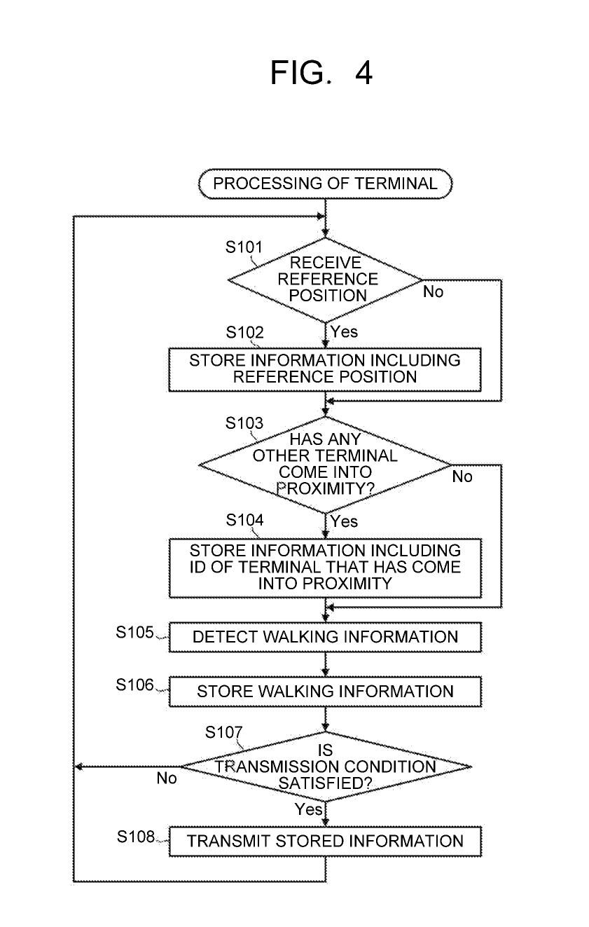

Next, the operation (processing) of the pedestrian terminals 111 to 113 will be described with reference to the flowchart in FIG. 4.

In each of the pedestrian terminals 111 to 113, when it is in the wireless communication area of the reference station 2 and thus is capable of communicating with the reference station 2, the control unit 12 receives the reference position from the reference station 2 (Step S101 in FIG. 4) and stores it as the position information of the own terminal in the storage unit 13 together with the time. That is, the control unit 12 stores information including the received reference position in the storage unit 13 (Step S102).

Further, the control unit 12 constantly monitors whether or not any of the other pedestrian terminals 111 to 113 approaches (Step S103). It detects the approach state by determining whether or not any of the other terminals exists within a several meter range from the own terminal, according to a change of the field intensity or the like.

Then, when any of the other pedestrian terminals 111 to 113 has come into proximity (Yes at Step S103), the terminal ID obtained from the terminal that has come into proximity out of the pedestrian terminals 111 to 113 is stored in the storage unit 13. That is, the control unit 12 stores information including the ID of the terminal that has come into proximity, in the storage unit 13 (Step S104).

When the walking information is detected by the walking sensor 11 (Step S105), the control unit 12 stores the detected walking information in the storage unit 13 (Step S106).

In this manner, pieces of the information are accumulated in the storage unit 13, and when a transmission condition is satisfied (Yes at Step S107), pieces of the information (the walking information of each of the terminals, the terminal ID of the own terminal, the obtained ID of the other terminal that has come into proximity, the time of passage, and so on) stored in the storage unit 13 are transmitted to the reference station 2 (Step S108).

The reference station 2 having received the information by the wireless communication with the pedestrian terminals 111 to 113 sends the received information to the server 3 together with the terminal IDs of the pedestrian terminals 111 to 113.

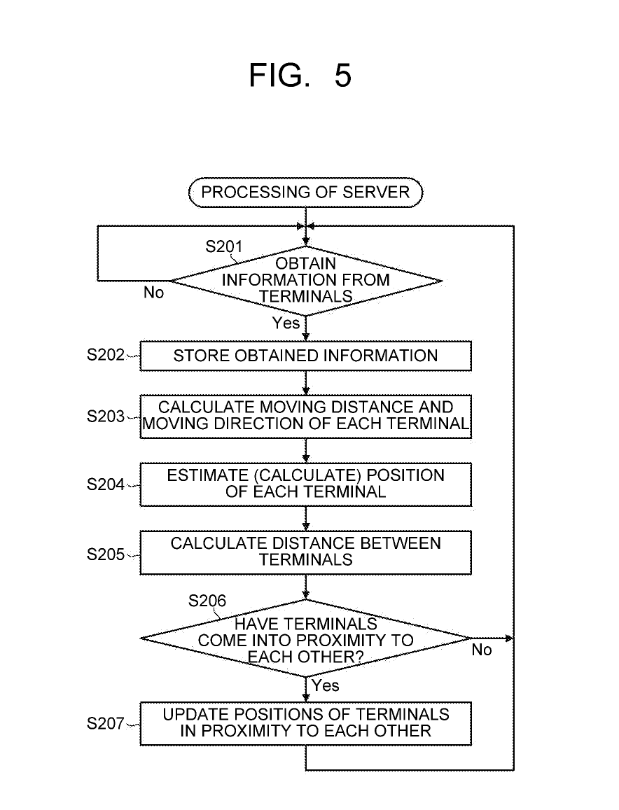

Next, the operation of the server 3 will be described with reference to the flowchart in FIG. 5. As illustrated in FIG. 5, in the server 3, when the communication unit 30 obtains the information of, for example, the pedestrian terminal 111 through the reference station 2 (Yes at Step S201), the communication unit 30 stores the obtained information in the storage unit 31 and at the same time gives the obtained information to the moving distance estimating unit 32 and the moving direction detecting unit 33.

The moving distance estimating unit 32 estimates the moving distance of the pedestrian terminal 111 from the reference position, based on the information of the pedestrian terminal 111 given from the communication unit 30 and the pre-stored reference position of the reference station 2. Further, the moving direction detecting unit 33 detects the moving direction based on the information of the pedestrian terminal 111 given from the communication unit 30. That is, these moving distance estimating unit 32 and moving direction detecting unit 33 calculate (estimate) the moving distance and the moving direction of the pedestrian terminal 111 based on the information of the pedestrian terminal 111 (Step S203).

Subsequently, the position calculating unit 34 calculates (estimates) the position of the pedestrian terminal 111 based on the moving distance of the pedestrian terminal 111 estimated by the moving distance estimating unit 32 and the moving direction detected by the moving direction detecting unit 33 (Step S204), and temporarily stores the calculated (estimated) position (estimated position) of the pedestrian terminal 111 in a temporary memory area different from the main position registration area of the storage unit 31.

The proximity determining unit 35 calculates the distance between the terminals based on the radio field intensities among the pedestrian terminals 111, 112, 113 given (obtained) from the communication unit 30 (Step S205), and determines whether or not the pedestrian terminal 111 and either of the other pedestrian terminals 112, 113 exist within the preset proximity range, that is, whether or not the terminals are in proximity to each other (Step S206).

When, as a result of this determination, the proximity determining unit 35 determines that, for example, the pedestrian terminal 111 and the pedestrian terminal 112 are in proximity to each other (Yes at Step S206), the position updating unit 36 updates (overwrites) the positions of the pedestrian terminals 111, 112 already registered in the storage unit 31, by using one or both of the positions (estimated positions) of the pedestrian terminals 111, 112 which are in proximity to each other (Step S207).

Incidentally, when, as a result of the proximity determination by the proximity determining unit 35, the proximity determining unit 35 determines that, for example, the pedestrian terminal 111 and the pedestrian terminal 112 are in proximity to each other, the position updating unit 36, without updating the positions immediately, may first determine whether or or not to update the positions of the pedestrian terminals 111, 112 already registered in the storage unit 13 by using one or both of the positions (estimated positions) of the pedestrian terminals 111, 112 which are in proximity to each other, and then when determining that the positions of the terminals are to be updated, may update (overwrite) the positions of these terminals stored in the storage unit 31 by using the calculated estimated position(s).

As described above, according to the first embodiment, pieces of the information of the pedestrian terminals 111 to 113, which are obtained from the reference station 2, are managed on the server 3, and in specifying the positions of the pedestrian terminals 111 to 113, the proximity of the moving pedestrian terminals 111 to 113 is determined, and by using the positions of the pedestrian terminals 111, 112 which are in proximity to each other, the positions of the relevant terminals which are registered in the storage unit 31 are updated. This makes it possible to accurately update the positions of the pedestrian terminals 111 to 113 moving by dead reckoning in the wireless communication area that can be covered by the single reference station 2.

### Second Embodiment

Next, a second embodiment will be described. Note that, in the second embodiment, the same structures as those in the first embodiment will be denoted by the same reference signs and a detailed description thereof will be omitted.

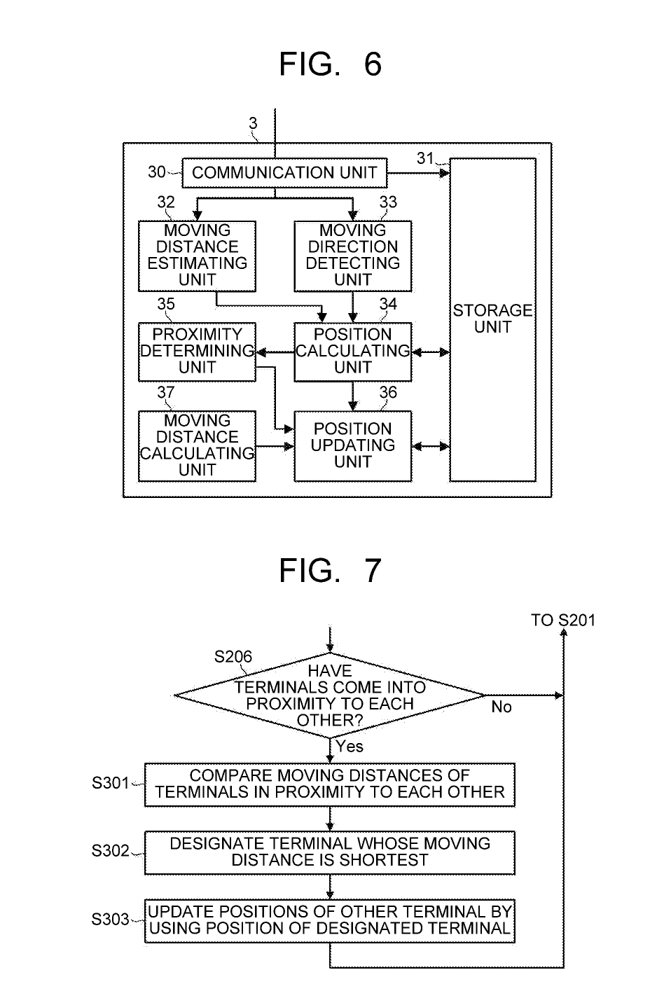

As illustrated in FIG. 6, in the second embodiment, a moving distance calculating unit 37 is provided in the server 3 of the first embodiment. The moving distance calculating unit 37 calculates current moving distances of pedestrian terminals 111 to 113 by which they have moved from points in time (positions, times) at which they pass a reference position, based on pieces of walking information (lengths of step, facing directions, times, and so on) obtained from the pedestrian terminals 111 to 113 and the pre-stored reference position.

That is, the moving distance calculating unit 37 calculates the moving distances of the pedestrian terminals 111 to 113 by which they have moved from the reference position, by using pieces of the walking information of the respective pedestrian terminals 111 to 113.

A position updating unit 36 compares the moving distances of the pedestrian terminals 111 to 113 calculated by the moving distance calculating unit 37, and by using a position of the terminal whose moving distance is the shortest out of the pedestrian terminals 111 to 113 existing within a range of a predetermined proximity distance, updates positions of the other terminals.

Next, the operation of the second embodiment will be described with reference to the flowchart in FIG. 7. In the case of the second embodiment, every time the estimated positions of the pedestrian terminals 111 to 113 are stored in a temporary memory area of a storage unit 31, a proximity determining unit 35 determines the proximity of the pedestrian terminals 111 to 113 (Step S206).

Here, when the proximity determining unit 35 determines that, for example, the pedestrian terminal 111 and the pedestrian terminal 112 exist within the range of the predetermined proximity range (for example, if the moving distance is 100 meters, the range of the proximity distance is about ±2 meters to about ±5 meters of 100 meters (for example, 97 meters to 103 meters or the like)), that is, determines that the terminals have come into proximity to each other (Yes at Step S206), the position updating unit 36 compares the moving distances of the pedestrian terminals 111, 112 which have come into proximity to each other (Step S301), and designates, for example, the terminal whose moving distance is the shortest (Step S302), and by using the estimated position of the designated terminal (in the case of the example in FIG. 1, the pedestrian terminal 111 because the moving distance of the pedestrian terminal 111 is the shortest), updates the positions of the terminals being update targets (in the case of the example in FIG. 1, the pedestrian terminals 111, 112) registered in a position registration area of the storage unit 31 (Step S303). When a proximity distance of the pedestrian terminals 111, 112 is within a range of ±2 meters, it is determined that this distance is within an error range, that is, that their moving distances are almost equal to each other.

As described above, according to the second embodiment, the moving distance calculating unit 37 is provided in the server 3, the moving distances of the pedestrian terminals 111 to 113 by which they have moved from the reference position are calculated, and when there exist the pedestrian terminals 111, 112 which are in proximity to each other, the positions of the pedestrian terminals 111, 112 being the update targets which are in proximity to each other are corrected by using the position of the pedestrian terminal 111 whose moving distance is the shortest. This enables highly accurate position correction in which an error in positioning the pedestrian terminals 111, 112 by dead reckoning is corrected.

Specifically, in the dead reckoning, as the moving distance from the reference position increases, the positioning error increases, and therefore, by correcting the positions of the pedestrian terminals 111, 112 stored in the storage unit 31 by using the calculated position (estimated position) of the pedestrian terminal whose moving distance from the reference position is the smallest, for example, the pedestrian terminal 111, it is possible to accurately update the positions of the pedestrian terminals 111, 112.

### Third Embodiment

Next, a third embodiment will be described. Note that, in the third embodiment, the same structures as those in the first embodiment will be denoted by the same reference signs and a detailed description thereof will be omitted.

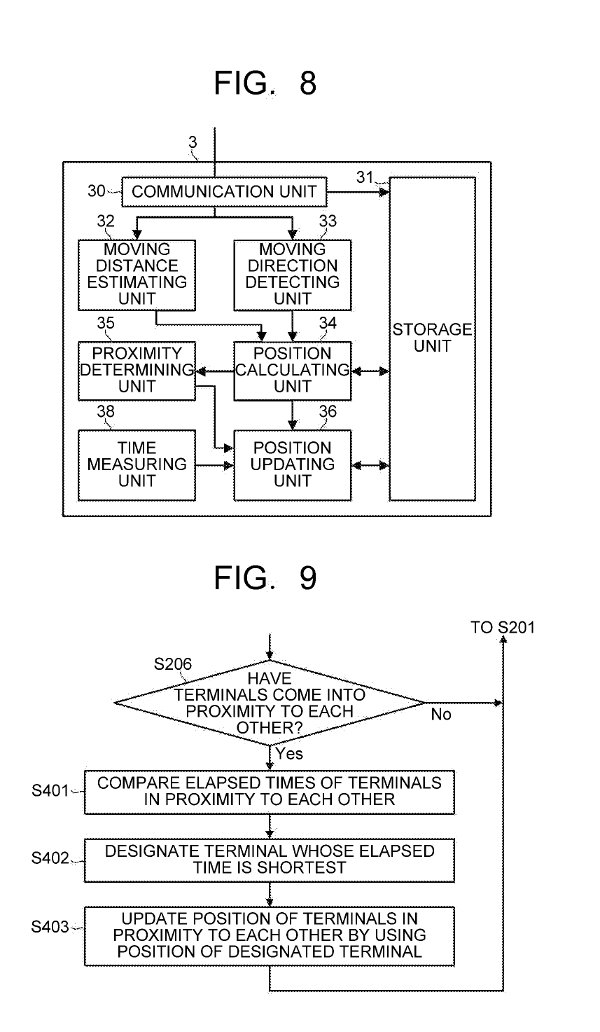

As illustrated in FIG. 8, in the third embodiment, a time measuring unit 38 as an elapsed time calculator is provided in the server 3 of the first embodiment. Based on pieces of walking information (lengths of step, facing directions, times, and so on) obtained from pedestrian terminals 111, 112 which have come into proximity to each other and a reference position stored in advance, the time measuring unit 38 measures (calculates) elapsed times from points in time (positions, times) at which they pass the reference position up to positions where the pedestrian terminals 111 to 113 currently exist.

That is, the time measuring unit 38 calculates the elapsed times of the pedestrian terminals 111, 112 elapsing after they pass the reference position, by using pieces of the walking information of the pedestrian terminals 111, 112 which have come into proximity to each other.

A position updating unit 36 compares the elapsed times of the pedestrian terminals 111, 112 calculated by the time measuring unit 38, and by using the position of the terminal whose elapsed time is the shortest (for example, the pedestrian terminal 111) out of the pedestrian terminals 111, 112 existing in a range of a predetermined proximity distance, updates a position of the other pedestrian terminal (for example, the pedestrian terminal 112) stored in the storage unit 31. In this case, since the elapsed time is used, there may be a case where the terminal whose elapsed time is the shortest is the pedestrian terminal 112.

Next, the operation of the third embodiment will be described with reference to the flowchart in FIG. 9. In the case of the third embodiment, every time estimated positions of the pedestrian terminals 111 to 113 are stored in a temporary memory area of the storage unit 31, a proximity determining unit 35 determines the proximity of the pedestrian terminals 111 to 113 (Step S206).

Here, when the proximity determining unit 35 determines that, for example, the pedestrian terminal 111 and the pedestrian terminal 112 exist within the range of the predetermined proximity distance, that is, that the terminals have come into proximity to each other (Yes at Step S206), the position updating unit 36 compares the elapsed times of the pedestrian terminals 111, 112 which have come into proximity to each other (Step S401), designates, for example, the terminal whose elapsed time is the shortest (Step S402), and by using the position of the designated terminal (for example, the pedestrian terminal 111), updates the positions of the update target terminals (for example, the pedestrian terminals 111, 112) registered in the storage unit 31 (Step S403).

As described above, according to the third embodiment, the time measuring unit 38 is provided in the server 3, the elapsed times having passed after the pedestrian terminals 111 to 113 move from the reference position are calculated, and when there exist the pedestrian terminals 111, 112 which are in proximity to each other, the positions of the update target terminals (pedestrian terminals 111, 112) are corrected by using the position of the pedestrian terminal 111 whose elapsed time is the shortest. This enables the high-accuracy position correction in which an error in positioning the pedestrian terminal 112 by dead reckoning is corrected.

Specifically, in the dead reckoning, as the elapsed time from the reference position becomes longer, a noise component increases, leading to an increase of the positioning error, and therefore, by using the calculated position (estimated position) of the pedestrian terminal whose elapsed time after its passage at the reference position is smaller, for example, the pedestrian terminal 111, the positions of the pedestrian terminals 111, 112 already registered in the storage unit 31 are corrected. This makes it possible to accurately update the position of the pedestrian terminal 112.

### Fourth Embodiment

Next, a fourth embodiment will be described. Note that, in the fourth embodiment, the same structures as those in the first to third embodiments will be denoted by the same reference signs and a detailed description thereof will be omitted.

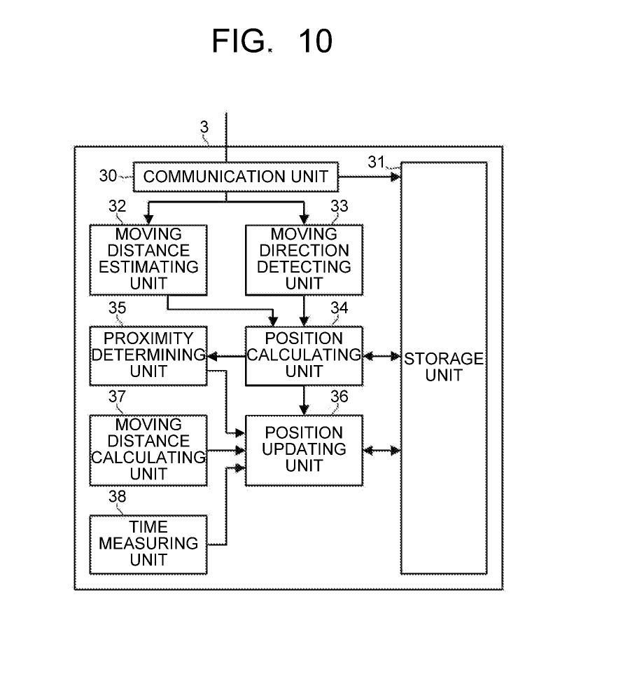

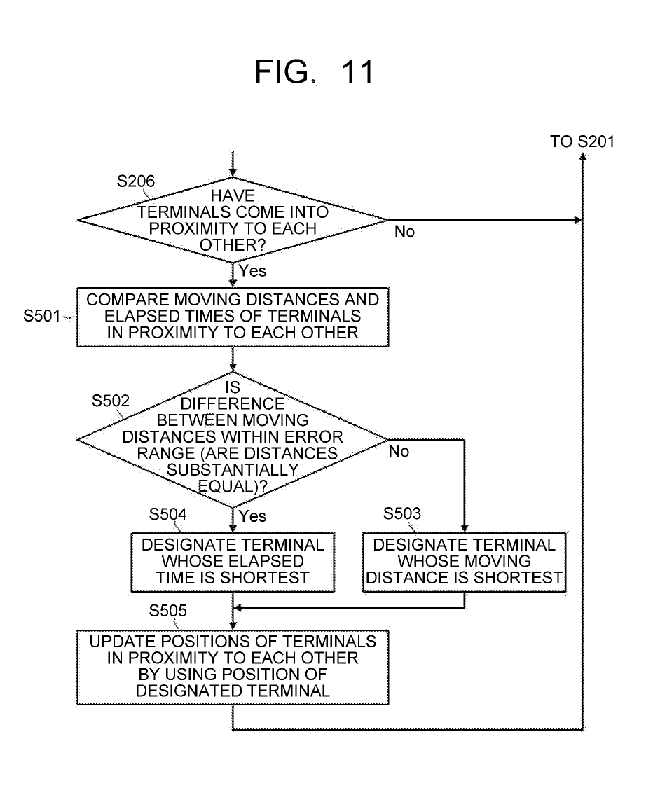

As illustrated in FIG. 10, the fourth embodiment is a combination of the second embodiment and the third embodiment, and a moving distance calculating unit 37 and a time measuring unit 38 are provided in a server 3.

The moving distance calculating unit 37 calculates current moving distances of respective pedestrian terminals 111 to 113 by which they have moved from points in time (positions, times) at which they pass a reference position, based on pieces of walking information (lengths of step, facing directions, times, and so on) obtained from the pedestrian terminals 111 to 113 and the reference position stored in advance.

The time measuring unit 38 measures (calculates) elapsed times from the points in time (positions, times) at which they pass the reference position up to positions where the pedestrian terminals 111 to 113 currently exist, based on pieces of the walking information (lengths of step, facing directions, times, and so on) obtained from the pedestrian terminals 111 to 113 and the reference position stored in advance.

Out of the pedestrian terminals 111, 112 which are in proximity to each other, a position updating unit 36 designates a pedestrian terminal whose moving distance calculated by the moving distance calculating unit 37 is the shortest, for example, the pedestrian terminal 111, as an update base terminal, and when there exist a plurality of terminals whose moving distances are equal, the position updating unit 36 designates, as the update base terminal, the pedestrian terminal whose elapsed time after it passes the reference position is shorter, and updates positions of the pedestrian terminals which are in proximity to each other, by using an estimated position of the designated update base pedestrian terminal. That the moving distances are equal means that a difference between the moving distances is within an error range.

Specifically, when a proximity determining unit 35 determines the proximity of at least two pedestrian terminals, for example, the pedestrian terminal 111 and the pedestrian terminal 112 out of the plural pedestrian terminals 111 to 113 and there exist the plural terminals whose moving distances are equal, the position updating unit 36 compares the elapsed times of the pedestrian terminals 111, 112 based on the estimated positions and the elapsed times, and by using the estimated position of the pedestrian terminal whose elapsed time is shorter, updates the positions of the update target pedestrian terminals, for example, the positions of the pedestrian terminal 111 and the pedestrian terminal 112, which are already registered in a storage unit 31. Next, the operation of the fourth embodiment will be described with reference to the flowchart in FIG. 11. In the case of the fourth embodiment, every time the estimated positions of the pedestrian terminals 111 to 113 are stored in a temporary memory area of the storage unit 31, the proximity determining unit 35 determines whether or not there exist the terminals which are in proximity to each other out of the plural pedestrian terminals 111 to 113 (Step S206).

Here, when the proximity determining unit 35 determines that, for example, the pedestrian terminal 111 and the pedestrian terminal 112 exist within a predetermined proximity range, that is, that the terminals are in proximity to each other (Yes at Step S206), the position updating unit 36 compares the moving distances and the elapsed times of the pedestrian terminals 111, 112 which are in proximity to each other (Step S501).

At this time, the position updating unit 36 first determines whether or not the difference between the moving distances of the pedestrian terminals 111, 112 which are in proximity to each other are within the preset error range (Step S502), to thereby determine whether or not they have moved up to substantially the same distance. Here, the error range is about 1% to about 2% of the moving distance, and for example, if the pedestrian terminals have moved 100 meters, the error range is about 1 meter to about 2 meters.

When, as a result of the determination of the moving distances, the difference between the moving distances of the pedestrian terminals 111, 112 which are in proximity to each other are not within the preset error range (No at Step S502), the position updating unit 36 designates the pedestrian terminal whose moving distance is the shortest (for example, the pedestrian terminal 111) (Step S503), and updates the positions of the pedestrian terminals 111, 112 being the update targets, by using the estimated position of the designated pedestrian terminal 111 (Step S505).

On the other hand, when, as a result of the above determination of the moving distances, the difference between the moving distances of the pedestrian terminals 111, 112 which are in proximity to each other is within the preset error range (Yes at Step S502), the position updating unit 36 subsequently compares the calculated elapsed times of the pedestrian terminals 111, 112, designates the pedestrian terminal whose elapsed time is the shortest (for example, the pedestrian terminal 111) (Step S504), and updates the positions of the pedestrian terminals 111, 112 being the update targets, by using the estimated position of the designated pedestrian terminal 111 (Step S505). Incidentally, in the case of the determination using the elapsed time, the pedestrian terminal whose elapsed time is shorter is designated even if its moving distance is longer, and therefore, there may be a case where the pedestrian terminal 112 in the example in FIG. 1 is designated.

As described above, according to the fourth embodiment, the moving distance calculating unit 37 and the time measuring unit 38 are provided in the server 3, and when the pedestrian terminals 111, 112 come into proximity to each other, it is determined which of the moving distance and the elapsed time is to be used in designating the estimated position, and the positions stored in the storage unit 31 are updated by using the estimated position designated as a result of the determination. This makes it possible to improve accuracy in specifying the positions of the pedestrian terminals 111 to 113.

Specifically, in dead reckoning, as the moving distance and the elapsed time from the reference position increase, a positioning error increases, and therefore, the terminal whose moving distance and the elapsed time from the reference position are smaller is designated, and based on its position, the already registered positions are updated. This makes it possible to update the positions of the pedestrian terminals 111, 112 registered and managed in the storage unit 31 by using the position with higher accuracy, and accordingly it is possible to correct the positions so that the positioning error is reduced.

### Fifth Embodiment

Next, a fifth embodiment will be described. Note that, in the fifth embodiment, the same structures as those in the first to fourth embodiments will be denoted by the same reference signs and a detailed description thereof will be omitted.

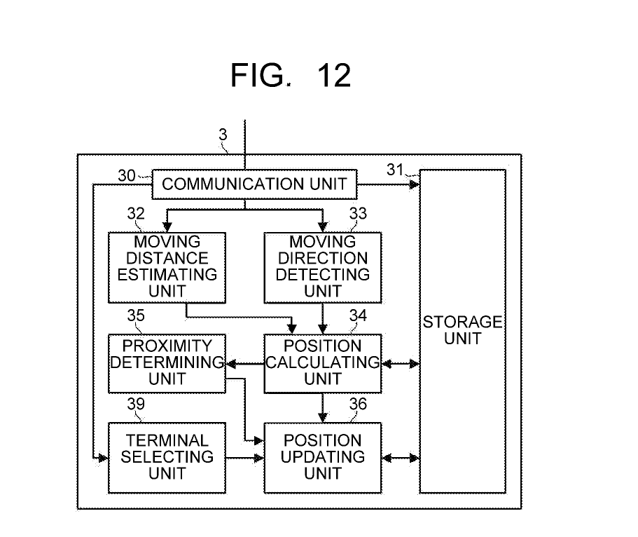

As illustrated in FIG. 12, in the fifth embodiment, a terminal selecting unit 39 is provided in a server 3. When the proximity of many pedestrian terminals 111 to 113 is determined based on distances between the pedestrian terminals 111 to 113 which are calculated by a proximity determining unit 35 based on positions of the pedestrian terminals 111 to 113 calculated by a position calculating unit 34, the terminal selecting unit 39 selects a pedestrian terminal used in the updating of position information, from the pedestrian terminals 111 to 113 according to a preset selection condition.

The selection condition is, for example, that only a terminal that is in proximity to only some terminal but is a predetermined distance or more apart from the other terminals is set as an update target terminal, or the like. Besides, various conditions are conceivable as the selection condition.

Incidentally, when many terminals are in proximity to one another, it is difficult to determine the proximity only based on a difference in field intensity, and therefore, for example, detection information obtained from, for example, ultrasonic sensors or image sensors, which are attached to the pedestrian terminals 111 to 113, may be used.

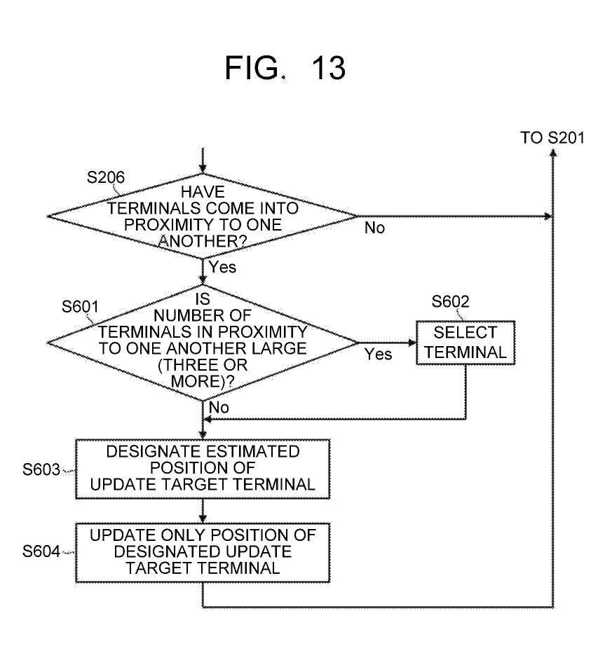

Next, the operation of the fifth embodiment will be described with reference to the flowchart in FIG. 13. In the case of the fifth embodiment, every time estimated positions of the pedestrian terminals 111 to 113 are stored in a temporary memory area of a storage unit 31, the proximity determining unit 35 determines whether or not there exist terminals in proximity to one another, out of the plural pedestrian terminals 111 to 113 (Step S206).

Here, when the proximity determining unit 35 determines that, for example, the pedestrian terminals 111 to 113 exist within a predetermined proximity range, that is, that the terminals are in proximity to one another (Yes at Step S206), the terminal selecting unit 39 determines whether or not the number of the pedestrian terminals in proximity to one another is three or more, that is, whether or not the number is large (Step S601), and when the number is large (Yes at Step S601), selects the pedestrian terminal whose position is to be updated, according to the preset selection condition (Step S602), and notifies it to a position updating unit 36.

The position updating unit 36 designates, as the update target, the position of the pedestrian terminal 113 which is at a more distant position, out of the pedestrian terminals 111 to 113 which are determined as being in proximity to one another by the proximity determining unit (Step S603), and by using the estimated position of the designated pedestrian terminal 113, updates the position of the pedestrian terminal 113 stored in the storage unit 31 (Step S604).

As described above, according to the fifth embodiment, the terminal selecting unit 39 is provided in the server 3, the terminal selecting unit 39 selects the update target pedestrian terminal out of the many pedestrian terminals which are in proximity to one another, according to the preset selection condition, only the selected terminal is set as the update target, and the position associated with a terminal identifier in the storage unit 31, corresponding to this pedestrian terminal is updated. Therefore, by updating the position of, for example, only the pedestrian terminal with a large cumulative error, it is possible to improve positioning accuracy, that is, reduce a positioning error, of the pedestrian terminal 113 with the large positioning error, by the updating of the position.

### Sixth Embodiment

Next, a sixth embodiment will be described. Note that, in the sixth embodiment, the same structures as those of the first to fifth embodiments will be denoted by the same reference signs and a detailed description thereof will be omitted.

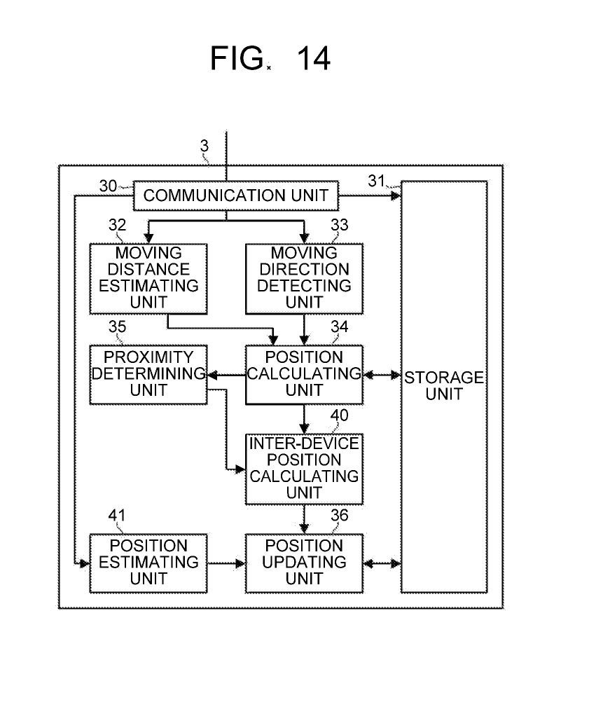

As illustrated in FIG. 14, in the sixth embodiment, an inter-device position calculating unit 40 and a position estimating unit 41 are provided in a server 3. The inter-device position calculating unit 40 calculates a relative positional distance and a relative direction between pedestrian terminals which are in proximity to each other out of pedestrian terminals 111 to 113. The position estimating unit 41 estimates current absolute positions of the pedestrian terminals 111 to 113 based on estimated positions, the relative distance, and the relative direction of the terminals which are in proximity to each other out of the pedestrian terminals 111 to 113.

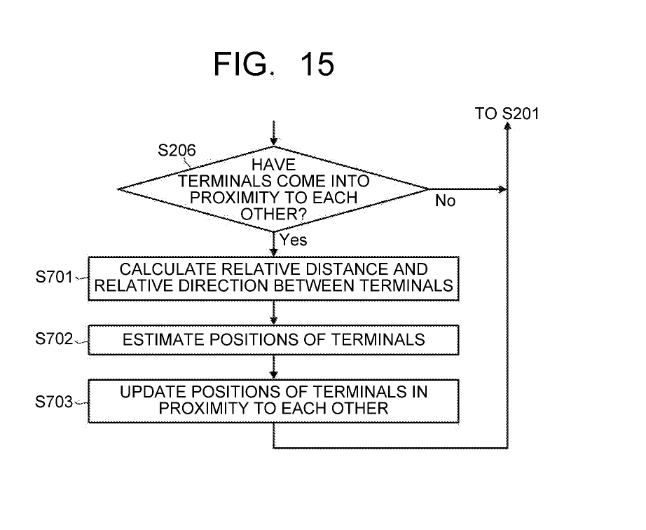

Next, the operation of the sixth embodiment will be described with reference to the flowchart in FIG. 15. In the case of the sixth embodiment, every time the estimated positions of the pedestrian terminals 111 to 113 are stored in a temporary memory area of a storage unit 31, a proximity determining unit 35 determines whether or not there exist terminals which are in proximity to each other out of the plural pedestrian terminals 111 to 113 (Step S206).

When the proximity determining unit 35 determines that the pedestrian terminal 111 and the pedestrian terminal 112 are in proximity to each other out of the plural pedestrian terminals 111 to 113, the inter-device position calculating unit 40 calculates the relative distance and the relative direction based on moving distances and/or elapsed times of the pedestrian terminals 111, 112 (Step S701), and the position estimating unit 41 estimates the positions of the pedestrian terminals 111, 112 based on the calculated relative distance and relative direction (Step S702).

A position updating unit 36 updates the positions, in the storage unit 31, of the two pedestrian terminals 111, 112 which are in proximity to each other, by using the estimated positions estimated by the position estimating unit 41 (Step S703).

As described above, according to the sixth embodiment, the relative distance and the relative direction between the pedestrian terminals 111, 112 which are in proximity to each other are found, the positions of the pedestrian terminals 111, 112 are estimated based on the found relative distance and relative direction, and based on the estimated positions, the positions of the pedestrian terminals 111 to 113 already registered in the storage unit 31 are updated. This makes it possible to correct also the position of the pedestrian terminal 113 which is not in proximity, to a position having a small positioning error.

### Seventh Embodiment

Next, a seventh embodiment will be described. Note that, in the seventh embodiment, the same structures as those in the first to sixth embodiments will be denoted by the same reference signs and a detailed description thereof will be omitted.

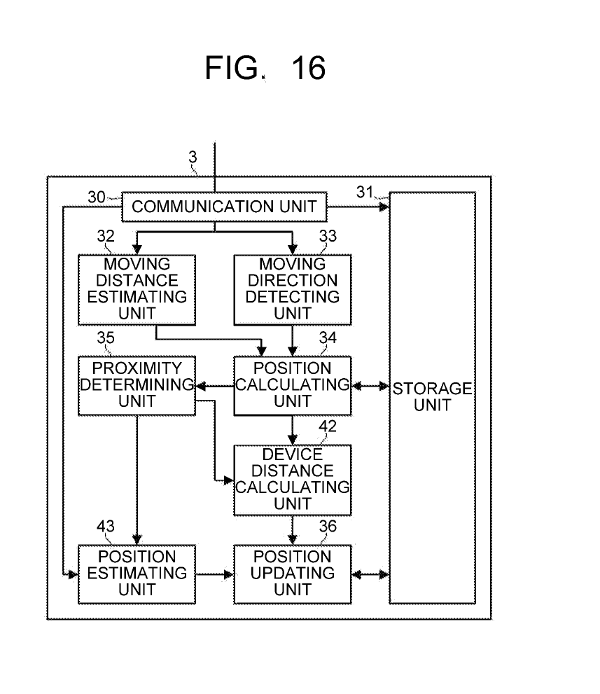

As illustrated in FIG. 16, in the seventh embodiment, a device distance calculating unit 42 and a position estimating unit 43 are provided in a server 3. The device distance calculating unit 42 calculates a relative distance between pedestrian terminals 111, 112, based on positions of the pedestrian terminals 111, 112 which are in proximity to each other, out of the pedestrian terminals 111 to 113.

The position estimating unit 43 functions as a second position estimator which estimates new positions of the pedestrian terminals 111 to 113 based on the positions and the relative distances of at least three or more of the pedestrian terminals 111 to 113 which are in proximity to one another.

A position updating unit 36 updates the positions of the terminals stored in a storage unit 31, by using the estimated positions estimated by the position estimating unit 43.

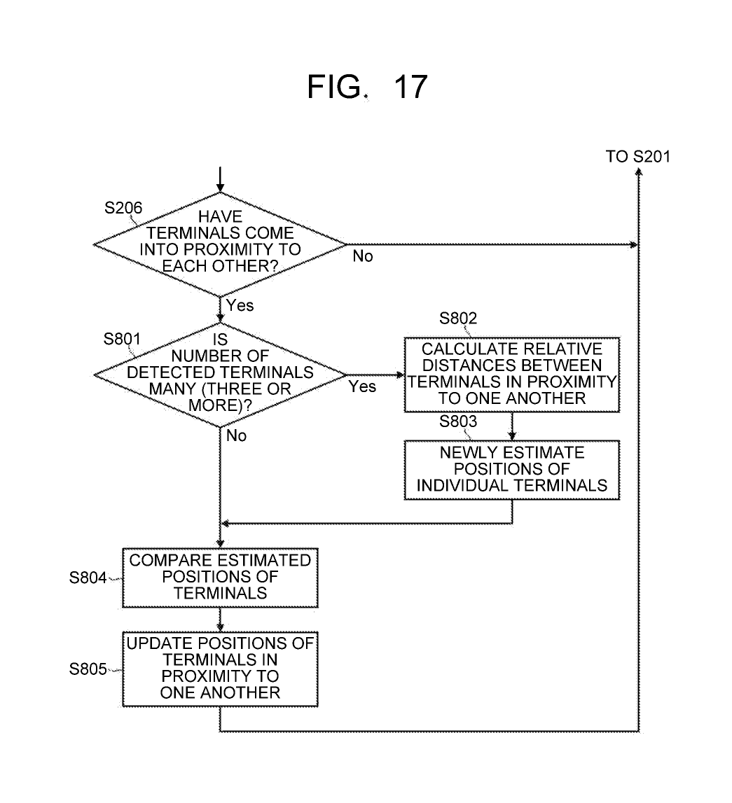

Next, the operation of the seventh embodiment will be described with reference to the flowchart in FIG. 17. In the case of the seventh embodiment, every time the estimated positions of the pedestrian terminals 111 to 113 are stored in a temporary memory area of the storage unit 31, a proximity determining unit 35 determines whether or not there exist terminals in proximity to each other out of the plural pedestrian terminals 111 to 113 (Step S206). Incidentally, the proximity determining unit 35 determines the proximity of the terminals by using the result of measuring radio field intensities of wireless communication of wireless LAN, WiFi, RFID, or the like.

When the proximity determining unit 35 determines that many (three or more) pedestrian terminals 111 to 113 out of the plural pedestrian terminals 111 to 113 are in proximity to one another (Yes at Step S801), the position estimating unit 43 calculates the relative distances based on the positions of the pedestrian terminals (Step S802), and further estimates the positions of the respective pedestrian terminals 111 to 113 based on the currently estimated positions and the calculated relative distances of the many pedestrian terminals (Step S803).

A position updating unit 36 updates the positions, in the storage unit 31, of the terminals which are in proximity to one another, by using the estimated positions of the pedestrian terminals calculated from the calculated positions and relative distances of the pedestrian terminals (Step S805).

As described above, according to the seventh embodiment, when the existence of the many pedestrian terminals which are in proximity to one another is detected, the positions of the pedestrian terminals which are in proximity to one another are updated by using data of the positions of the many pedestrian terminals. This makes it possible to improve accuracy of position correction also of the pedestrian terminal which is not in proximity. Further, in this embodiment, even when the relative direction is not found, it is possible to improve positioning accuracy

### Eighth Embodiment

Next, an eighth embodiment will be described. Note that, in the eighth embodiment, the same structures as those in the first to seventh embodiments will be denoted by the same reference signs and a detailed description thereof will be omitted.

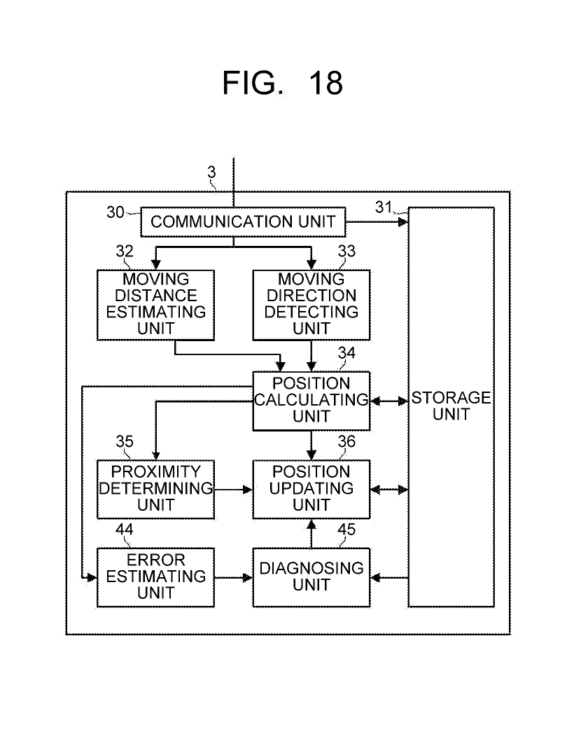

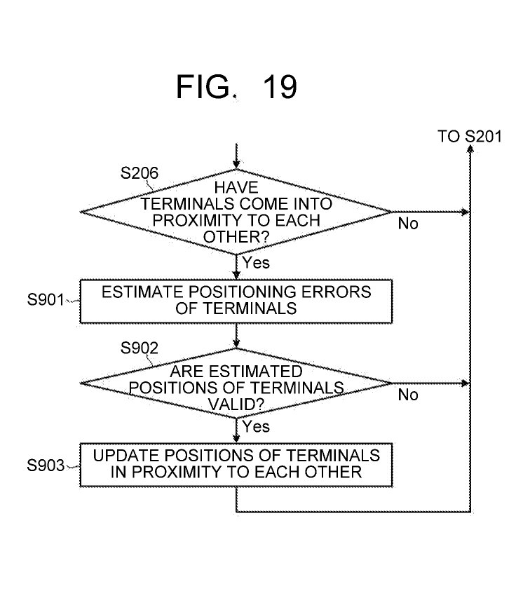

As illustrated in FIG. 18, in the eighth embodiment, an error estimating unit 44 and a diagnosing unit 45 are provided in a server 3. The error estimating unit 44 estimates positioning errors based on moving distances and moving directions of pedestrian terminals 111 to 113 which are in proximity to one another.

The diagnosing unit 45 calculates differences between positions of the pedestrian terminals 111, 112 in proximity to each other, which are calculated by a position calculating unit 34, and the positioning errors, and compares the calculated differences and estimated positions of the pedestrian terminals 111, 112 being update targets, and determines validity of the estimated positions of the pedestrian terminals 111, 112 which are estimated.

Specifically, the diagnosing unit 45 determines that the estimated position is valid when the estimated position is within a range of the positioning error, and determines that the estimated position is not correct, that is, the estimation of the position is a mistake, when the estimated position falls out of the range of the positioning error.

By using the estimated positions determined as valid by the diagnosing unit 45, a position updating unit 36 updates the positions, in a storage unit 31, of the relevant terminals which are in proximity to each other.

Next, the operation of the eighth embodiment will be described with reference to the flowchart in FIG. 19. In the case of the eighth embodiment, every time the estimated positions of pedestrian terminals 111 to 113 are stored in a temporary memory area of the storage unit 31, a proximity determining unit 35 determines whether or not there exist terminals in proximity to each other out of the plural pedestrian terminals 111 to 113 (Step S206). Incidentally, the proximity determining unit 35 determines the proximity of the terminals by using the result of measuring radio field intensities of wireless communication of wireless LAN, WiFi, RFID, or the like.

When the proximity determining unit 35 determines that there exist the pedestrian terminals 111 to 113 which are in proximity to one another, the error estimating unit 44 estimates the positioning errors based on the moving distances and the moving directions of the pedestrian terminals 111 to 113 which are in proximity to one another (Step S901). The positioning error increases in proportion to the moving distance, and is calculated by a mathematical formula.

Subsequently, the diagnosing unit 45 determines the validity of the estimated positions of the pedestrian terminals 111 to 113 which are in proximity to one another (Step S902). In this case, the diagnosing unit 45 collates the estimated positions of the pedestrian terminals 111 to 113 calculated by the position calculating unit 34 and the positions of the pedestrian terminals 111 to 113 found from the moving distances, and when the differences between the former and latter positions are within the range of the positioning errors estimated by the error estimating unit 44, determines that the estimated positions of the terminals calculated by the position calculating unit 34 are valid.

That is, by comparing and collating the ranges of the positioning errors at the moving distances estimated by the error estimating unit 44 and the positions of the pedestrian terminals 111 to 113 which are targets of position updating, it is determined whether or not the estimated positions are valid.

When, as a result of the determination by the diagnosing unit 45 regarding the validity of the estimated positions, it is determined that the estimated positions of the pedestrian terminals 111 to 113 which are in proximity to one another are valid (Yes at Step S902), by using the estimated positions of the pedestrian terminals 111 to 113 which are determined as valid by the diagnosing unit 45, the position updating unit 36 updates the positions, in the storage unit 31, of the relevant terminals 111 to 113 which are in proximity to one another (Step S903).

Incidentally, when the estimated position of the pedestrian terminal is determined as not being valid by the diagnosing unit 45, the position updating unit 36 does not update the position of the relevant terminal.

As describe above, according to the eighth embodiment, the diagnosing unit 45 is provided in the server 3, and after the diagnosing unit 45 first determines the validity of the estimated positions, the positions, in the storage unit 31, of the terminals 111 to 113 which are in proximity to one another are updated, by using the valid estimated positions of the pedestrian terminals 111 to 113 which are in proximity to one another. Therefore, in other words, the pedestrian terminal whose estimated position has a possibility of error is excluded (error exclusion), and it is possible to update only the position of the pedestrian terminal whose estimated position has a smaller error. This can improve positioning accuracy as the whole system.

As described above, according to the above-described embodiments, after the terminals 111 to 113 each worn by the walking body pass the reference position, the server 3 obtains, via the reference station 2, the information sent from the terminals 111 to 113 by the wireless communication, and the server 3 detects the proximity of the plural terminals 111 to 113 based on the obtained information of the terminals 111 to 113, estimates the positions of the individual terminals based on the walking information of the terminals 111 to 113 which are in proximity to each other, and updates the already registered positions of the terminals 111 to 113 by using the estimated positions. This makes it possible to improve positioning accuracy of the positions of the walking bodies (terminals) by using the minimum positioning infrastructure (the reference station 2, the server 3, and the communication network 4).

That is, the proximity of the plural terminals which wirelessly transmit the walking information by the dead reckoning is detected, their positions are estimated, and the already registered positions of the terminals are updated by using the estimated positions. This makes it possible to improve the positioning accuracy of the terminals (walking bodies) by making use of the minimum positioning infrastructure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above-described embodiments, based on the information obtained from the plural pedestrian terminals 111, 112 which are in proximity to each other, the position updating unit 36 finds the estimated positions of the pedestrian terminals 111, 112 which are in proximity to each other, and updates the positions of the pedestrian terminals 111, 112 by using the found estimated positions, but an alternative way in updating the positions may be that, after it is first determined whether to update the positions or not, the positions is updated when they are to be updated, and the positions are not updated when the updating is not necessary. That is, a determination process may be included at the time of the position updating.

In the above-described embodiments, the structures such as the storage unit 31, the moving distance estimating unit 32, the moving direction detecting unit 33, the position calculating unit 34, the proximity determining unit 35, and the position updating unit 36 are provided in the server 3, but they may be provided in each of the pedestrian terminals 111 to 113 and the position updating unit 36 may update the position stored in the storage unit 31 in each of the terminals. Further, only the storage unit 31 may be disposed in the server 3, and from the pedestrian terminals 111 to 113, the positions of the own terminals may be updated.

Further, in the above-described embodiments, the example where the pedestrian terminals each are carried by the pedestrian (person) is described, but besides, the walking body may be, for example, a multilegged walking animal (a dog or a cat), a robot, and the like, provided that the pedestrian terminal moves together with the walking body, and the terminals may be terminals worn by or attached to them.

Further, the constituent elements illustrated in the above-described embodiments may be realized by programs installed in a storage such as a hard disk device of a computer, or the aforesaid programs may be stored in computer-readable electronic media and the computer may realize the functions of the present invention by reading the programs from the electronic media. The electronic media include, for example, recording media such as CD-ROM, a flash memory, removable media, and the like. Alternatively, the constituent elements may be stored in different computers connected via a network, in a distributed manner, and the constituent elements may be realized by the mutual communication among the computers in which the constituent elements are made to function.

What is claimed is:

1. An information processing apparatus connected to a wireless base station configured to wirelessly communicate with a plurality of terminals, the wireless base station providing a predetermined point on a map to each of the plurality of the terminals as a reference position serving as a positioning reference, each of the plurality of terminals being configured to obtain walking information indicating a walking movement of a walking user, each of the plurality of the terminals initially passing the reference position with the walking user, the information processing apparatus comprising:
an information acquisition processor to obtain the walking information, an identification information, a passage time at the reference position, and a radio field intensity on inter-terminal communication with a counterpart terminal from each of the plurality of the terminals;
a position calculator to calculate an estimated position of each of the plurality of the terminals based on the walking information of each of the plurality of the terminals sequentially obtained by the information acquisition processor when and after each of the plurality of the terminals passes the reference position;
a memory to store a measured position of each of the plurality of the terminals in association with a respective identification information of each of the plurality of the terminals;
a proximity detector to determine existence of a proximity terminal within a range of a preset proximity distance based on the radio field intensity on the inter-terminal communication for each of the plurality of the terminals obtained from each of the plurality of the terminals; and
a position updater to update the measured positions of the relevant terminal within the range of the proximity distance stored in the memory by using the estimated position of the proximity terminal determined as existing within the range of the proximity distance by the proximity detector.

2. The information processing apparatus of claim 1, further comprising
a moving distance calculator to calculate a moving distance of each of the plurality of terminals from the reference position based on the walking information of each of the plurality of the terminals,
wherein the position updater compares the moving distance of each of the plurality of the terminals calculated by the moving distance calculator, and updates the measured position of the relevant terminal within the range of the proximity distance stored in the memory with an estimated position of a closest terminal, the closest terminal having shortest moving distance among the plurality of the terminals within the range of the proximity distance.

3. The information processing apparatus of claim 1, further comprising
an elapsed time calculator to calculate a elapsed time having passed after each of the plurality of the terminals passes the reference position,
wherein the position updater compares the elapsed time of each of the plurality of the terminals calculated by the elapsed time calculator, and updates the measured position of the relevant terminal within the range of the proximity distance stored in the memory with an estimated position of an closest terminal, the closest terminal having shortest elapsed time among the plurality of the terminals within the range of the proximity distance.

4. The information processing apparatus of claim 1, further comprising:
a moving distance calculator to calculate a moving distance of each of the plurality of the terminals from the reference position based on the walking information of each of the plurality of the terminals; and
an elapsed time calculator to calculate a elapsed time having passed after each of the plurality of the terminals passes the reference position,
wherein the position updater designates:
an estimated base position of an update base terminal having shortest moving distance among the plurality of the terminals calculated by the moving distance calculator; or
an estimated base position of an update base terminal having shortest moving distance and shortest elapsed time after passage of the reference position when two or more of terminals among the plurality of the terminals have substantially equal moving distance, and
updates the measured position of the relevant terminal within the range of the proximity distance stored in the memory with the estimated base position.

5. The information processing apparatus of claim 1,
wherein, when two or more of terminals exist within the range of the proximity distance, the position updater designates an estimated target position of an update target terminal having moving distance and/or elapsed time within a preset threshold value, and updates the measured position of the update target terminal with the estimated target position.

6. The information processing apparatus of claim 1, further comprising:
a moving distance calculator to calculate a moving distance of each of the plurality of the terminals from the reference position;
an error estimator to estimate a positioning error in the moving distance calculated by the moving distance calculator; and
a diagnoser to collate the estimated position of each of the plurality of the terminals calculated by the position calculator and a calculated position of each of plurality of the terminals found from the moving distance, and determines that the estimated position of each of the plurality of the terminal calculated by the position calculator is valid when a difference between the estimated position and the calculated position is within a range of the positioning error estimated by the error estimator,
wherein the position updater updates the measured position of the relevant terminal within the range of the proximity distance stored in the memory with the estimated position of the relevant terminal determined as being valid by the diagnoser, and the position updater does not update the measured position of the relevant terminal when the estimated position of the relevant terminal is determined as not being valid.

7. A positioning method in an information processing apparatus connected to a wireless base station configured to wirelessly communicate with a plurality of terminals, the wireless base station providing a predetermined point on a map to each of the plurality of the terminals as a reference position serving as a positioning reference, each of the plurality of terminals being configured to obtain walking information indicating a walking movement of a walking user, each of the plurality of the terminals initially passing the reference position with the walking user, the positioning method comprising:
obtaining the walking information, an identification information, a passage time at the reference position, and a radio field intensity on inter-terminal communication with a counterpart terminal from each of the plurality of the terminals;
calculating an estimated position of each of the plurality of the terminals based on the walking information of each of the plurality of the terminals sequentially obtained by the information acquisition processor when and after each of the plurality of the terminals passes the reference position;
storing a measured position of each of the plurality of the terminals in association with a respective identification information of each of the plurality of the terminals, in a memory;
determining existence of a proximity terminal within a range of a preset proximity distance based on the radio field intensity on the inter-terminal communication for each of the plurality of the terminals obtained from each of the plurality of the terminals; and
updating the measured positions of the relevant terminal within the range of the proximity distance stored in the memory by using the estimated position of the proximity terminal determined as existing within the range of the proximity distance.

8. The positioning method of claim 7, further comprising
calculating a moving distance of each of the plurality of terminals from the reference position based on the walking information of each of the plurality of the terminals,
comparing the moving distance of each of the plurality of the terminals calculated, and updating the measured position of the relevant terminal within the range of the proximity distance stored in the memory with an estimated position of a closest terminal, the closest terminal having shortest moving distance among the plurality of the terminals within the range of the proximity distance.

9. The positioning method of claim 7, further comprising
calculating a elapsed time having passed after each of the plurality of the terminals passes the reference position,
comparing the elapsed time of each of the plurality of the terminals calculated by the elapsed time calculator, and updating the measured position of the relevant terminal within the range of the proximity distance stored in the memory with an estimated position of an closest terminal, the closest terminal having shortest elapsed time among the plurality of the terminals within the range of the proximity distance.

10. The positioning method of claim 7, further comprising:
calculating a moving distance of each of the plurality of terminals from the reference position based on the walking information of each of the plurality of the terminals,
calculating a elapsed time having passed after each of the plurality of the terminals passes the reference position,
designating:
an estimated base position of an update base terminal having shortest moving distance among the plurality of the terminals calculated; or,
an estimated base position of an update base terminal having shortest moving distance and shortest elapsed time after passage of the reference position when two or more of terminals among the plurality of the terminals have substantially equal moving distance, and
updating the measured position of the relevant terminal within the range of the proximity distance stored in the memory with the estimated base position.

11. The positioning method of claim 7,
wherein, when two or more of terminals exist within the range of the proximity distance, designating an estimated target position of an update target terminal having moving distance and/or elapsed time within a preset threshold value, and updating the measured position of the update target terminal with the estimated target position.

12. The positioning method of claim 7, further comprising:
calculating a moving distance of each of the plurality of the terminals from the reference position;
estimating a positioning error in the moving distance calculated; and
collating the estimated position of each of the plurality of the terminals calculated and a calculated position of each of plurality of the terminals found from the moving distance, and determining that the estimated position of each of the plurality of the terminal calculated is valid when a difference between the estimated position and the calculated position is within a range of the positioning error estimated,
updating the measured position of the relevant terminal within the range of the proximity distance stored in the memory with the estimated position of the relevant terminal determined as being valid, and does not updating the measured position of the relevant terminal when the estimated position of the relevant terminal is determined as not being valid.

13. A storage medium storing a program causing an information processing apparatus connected to a wireless base station configured to wirelessly communicate with a plurality of terminals, the wireless base station providing a predetermined point on a map to each of the plurality of the terminals as a reference position serving as a positioning reference, each of the plurality of terminals being configured to obtain walking information indicating a walking movement of a walking user, each of the plurality of the terminals initially passing the reference position with the walking user, and the storage medium being the information processing apparatus-readable storage medium storing a program causing the information processing apparatus to function including:
an information acquisition processor to obtain the walking information, an identification information, a passage time at the reference position, and a radio field intensity on inter-terminal communication with a counterpart terminal from each of the plurality of the terminals;
a position calculator to calculate an estimated position of each of the plurality of the terminals based on the walking information of each of the plurality of the terminals sequentially obtained by the information acquisition processor when and after each of the plurality of the terminals passes the reference position;
a memory to store a measured position of each of the plurality of the terminals in association with a respective identification information of each of the plurality of the terminals;
a proximity detector to determine existence of a proximity terminal within a range of a preset proximity distance based on the radio field intensity on the inter-terminal communication for each of the plurality of the terminals obtained from each of the plurality of the terminals; and
a position updater to update the measured positions of each of the plurality of the terminals stored in the memory by using the estimated position of the proximity terminal determined as existing within the range of the proximity distance by the proximity detector.

14. The storage medium of claim 13, the program causing the information processing apparatus to further function including
a moving distance calculator to calculate a moving distance of each of the plurality of terminals from the reference position based on the walking information of each of the plurality of the terminals,
wherein the position updater compares the moving distance of each of the plurality of the terminals calculated by the moving distance calculator, and updates the measured position of each of the plurality of the terminals stored in the memory with an estimated position of a closest terminal, the closest terminal having shortest moving distance among the plurality of the terminals within the range of the proximity distance.

15. The storage medium of claim 13, the program causing the information processing apparatus to further function including
an elapsed time calculator to calculate a elapsed time having passed after each of the plurality of the terminals passes the reference position,
wherein the position updater compares the elapsed time of each of the plurality of the terminals calculated by the elapsed time calculator, and updates the measured position of each of the plurality of the terminal stored in the memory with an estimated position of an closest terminal, the closest terminal having shortest elapsed time among the plurality of the terminals within the range of the proximity distance.

16. The storage medium of claim 13, the program causing the information processing apparatus to further function including:
a moving distance calculator to calculate a moving distance of each of the plurality of the terminals from the reference position based on the walking information of each of the plurality of the terminals; and
an elapsed time calculator to calculate a elapsed time having passed after each of the plurality of the terminals passes the reference position,
wherein the position updater designates:
an estimated base position of an update base terminal having shortest moving distance among the plurality of the terminals calculated by the moving distance calculator; or
an estimated base position of an update base terminal having shortest moving distance and shortest elapsed time after passage of the reference position when two or more of terminals among the plurality of the terminals have substantially equal moving distance, and
updates the measured position of each of the plurality of the terminals stored in the memory with the estimated base position.

17. The storage medium of claim 13,
wherein, when two or more of terminals exist within the range of the proximity distance, the position updater designates an estimated target position of an update target terminal having moving distance and/or elapsed time within a preset threshold value, and updates the measured position of each of the plurality of terminals with the estimated target position.

18. The storage medium of claim 13, the program causing the information processing apparatus to further function including:
a moving distance calculator to calculate a moving distance of each of the plurality of the terminals from the reference position;
an error estimator to estimate a positioning error in the moving distance calculated by the moving distance calculator; and
a diagnoser to collate the estimated position of each of the plurality of the terminals calculated by the position calculator and a calculated position of each of plurality of the terminals found from the moving distance, and determines that the estimated position of each of the plurality of the terminal calculated by the position calculator is valid when a difference between the estimated position and the calculated position is within a range of the positioning error estimated by the error estimator,
wherein the position updater updates the measured position of the relevant terminal within the range of the proximity distance stored in the memory with the estimated position of the relevant terminal determined as being valid by the diagnoser, and the position updater does not update the measured position of the relevant terminal when the estimated position of the relevant terminal is determined as not being valid.
